(19) United States
(12) Patent Application Publication
(10) Pub. No.: US 2005/0173884 A1
(43) Pub. Date: Aug. 11, 2005

(54) Retrofit front suspension stabilization system for straight axle vehicles with lift kits

(76) Inventors: Larry Ware, Belton, TX (US); Curtis Maggard, Belton, TX (US)

Correspondence Address: David G. Henry, 900 Washington Ave., P.O. Box 1470, Waco, TX, 76703-1470, US

(21) Appl. No.: 10/775,800

(22) Filed: Feb. 10, 2004

(51) Int. Cl. B60G 9/04; B60G 1/00

(52) U.S. Cl. 280/124.156

(57) ABSTRACT

A stabilization system for front suspensions of vehicles, particularly for four-wheel drive, off road vehicles with straight axles. The system includes an axle mounting plate, an adjustable rod with hime joints at either end, and a chassis mounting plate for securing the adjustable rod to a portion of the vehicle's chassis substantially vertically of the axle. The substantially rigid linkage between the front axle and the chassis in the manner depicted, has the effect of significantly stabilizing the vehicle against lateral rocking associated particularly with the presence of lift kits in such vehicles.

### BACKGROUND OF THE INVENTION

1. Field of the Invention

The present invention relates to vehicle suspensions and modifications thereto.

2. Background Information

A very popular form of recreation involves the use of sport vehicles to traverse a variety of off-road environments. An example of such a vehicle is the classic version of the JEEP brand vehicles.

As off-road enthusiasts encounter ever more challenging terrain, a stock vehicle, even one designed for off-road use (like versions of the original JEEP brand vehicles), is not always up to the task. The issue is not always adequate power, or even traction, but primarily one of ground clearance. Whether to avoid becoming “high-grounded”, or even more importantly, to avoid damage to the underside components of the vehicle, raising the vehicle relative to the ground is a frequent solution. This involves installing “life kits.”

A particular stability problem is associated with straight axle versions of vehicles with lift kits (as opposed to those having independent front suspension). Even when not in motion mere moving of a steering wheel from side to side causes these vehicles to rock from side to side—a problem which is greatly magnified when the vehicle is in motion, and even more so over rough terrain.

Lack of vehicle stability is always a safety issue, particularly for vehicles which are, even in stock configuration, known for higher roll-over risks than standard vehicles. Adding the above stability issues through addition of a lift kit to a straight axle JEEP vehicle, for example, creates a near intolerable safety issue, particularly if the vehicle will be driven on public streets and highways, and at normal speeds.

Given the fact that owners of suitable off-road vehicles simply will install lift kits, as there are, at present, no legal prohibitions to the contrary, it would well serve the interests of these vehicles, as well as society in general, to provide some means by which some degree of safety can be returned to straight axle off-road vehicles, even after the addition of a lift kit.

### SUMMARY OF THE INVENTION

In view of the foregoing, it is an object of the present invention to provide an apparatus for modifying a straight axle off road vehicle for increasing the stability thereof.

It is another object of the present invention to provide an apparatus for modifying a straight axle, off road vehicle in which a lift kit has been installed for increasing the stability thereof.

It is another object of the present invention to provide a method for increasing the stability of a straight axle, off road vehicle in which a lift kit has been installed.

It is another object of the present invention to provide a method for modifying a straight axle, off road vehicle in which a lift kit has been installed for increasing the stability thereof.

In satisfaction of these and other related objectives, Applicant's present invention provides and apparatus and associated method for modifying a straight axle, off-road vehicle for increasing the stability of the vehicle. The apparatus (which might also be described as a “kit” or “system” includes a first plate which attaches to the front axle of the vehicle, an adjustable rod with hime joints on either end, and a second plate which attaches to the vehicle's chassis.

The substantially rigid linkage between the axle and the vehicle chassis, which exists upon installation of the present system, provides a very effective counter-measure against the lateral shifting of the vehicle's chassis and the axle—the principle source of the subject vehicles' stability problems.

Initial trials reveal that the addition of the present system (nothing similar to which is known to exist for straight axle, off road vehicles such as earlier JEEP brand vehicles) substantially enhances the vehicle's stability, especially (though not solely) when installed in a vehicle already having a lift kit.

### BRIEF DESCRIPTION OF THE DRAWINGS

FIG. 1 is a perspective, partially exploded view of a generic example of the components of the present system, shown in relation to the principle vehicle components to which, or in relation to which, the system components are to be installed (respective points of attachment being indicated by dashed lines).

### DETAILED DESCRIPTION OF THE PREFERRED EMBODIMENT

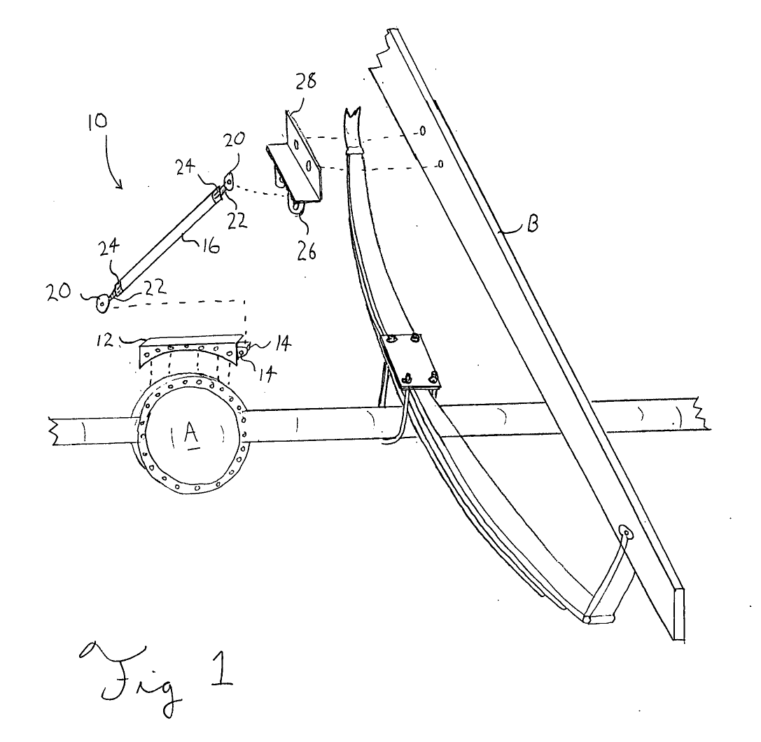

With reference to FIG. 1, the system or kit of the present invention is identified generally by the reference number 10.

System 10 includes an axle attachment plate 12. Axle attachment plate 12, in the preferred embodiment, is sized, shaped and configured for attachment to the differential A of a four wheel drive, straight axle vehicle. As is clear from the drawing, axle attachment plate is designed to attach to the differential A using the same bolts or studs as secure the differential's access plate. Thus, installation is very straight forward and requires no permanent or time-consuming modification to the vehicle or its components. Mounting tabs 14 extend from axle attachment plate 12 for receiving and interfacing with an eye-member structure (to be described hereafter).

An alternative embodiment of an axle attachment plate for use with a non-four wheel drive vehicle (not having a front differential) may include a different version of the axle attachment plate which is not configured as just described.

System 10 next includes a stabilization rod member 16. It is this member which provides the rigid linkage between the axle (or differential, which, functionally, is a part thereof) and the vehicle's chassis (a portion of which is identified by the reference character B in the drawing).

The stabilization rod member 16 of the preferred embodiment of the present system 10 includes hime joints 18 on each end, each having an eye member 20. This configuration involves each terminus of stabilization rod member 16 having a threaded orifice, into which a threaded stud 22 is received and of which, in turn, eye members 20 are respective parts. Nuts 24 secure threaded studs 22 in the desired orientation and extent of reception into stabilization rod member 16.

One of the two eye members 20 are to be interfaced with mounting tabs 14 of axle attachment plate 12, the other to be interfaced with mounting tabs 26 of chassis attachment plate 28.

Chassis attachment plate 28 is (as depicted in the drawing) to be attached to chassis B of the vehicle. This attachment may involve drilling holes and using conventional nuts and bolts (not shown in the drawing). Also, of course, the attachment may be made by welding.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. In particular, it should be noted that reference to JEEP brand vehicles is merely the presently envisioned best application of the present invention. Other vehicles, including some by FORD, CHEVROLET, DODGE and TOYOTA and which may be modified with a lift kit will likewise benefit from use of the present system and method.

It is, therefore, contemplated that the appended claims will cover such modifications that fall within the scope of the invention.

1. A stabilization system for the front suspension of a vehicle comprising:
an axle attachment plate configured for attachment with a front axle member of a vehicle, said axle attachment plate having first stabilization rod securing means;
a chassis attachment plate configured for attachment to a chassis of a vehicle near a front axle thereof;
a stabilization rod member having first and second stabilization rod member ends, a first and second threaded orifices being positioned respectively at said first and second stabilization rod ends;
first and second eye members respectively having first and second threaded studs extending from an eye structure thereof, said first and second threaded studs being configured for adjustable threaded engagement with said first and second threaded orifices of said of said first stabilization rod member, said eye structure of said first eye member being configured for securement to said first stabilization rod securing means of said axle attachment plate, and said second eye being configured for securement to said second stabilization rod securing means of said chassis attachment plate;
first and second eye member securing members for securing said first and second eye members in a threaded engagement with said stabilization rod member.

2. The system of claim 1 wherein said axle attachment plate is configured for attachment to the differential portion of said axle of said vehicle, said axle attachment plate having mounting holes which, in spacing and configuration, correspond with bolts holding an access plate of said differential in place, whereby said axle attachment plate may be mounted to said axle using said bolts of said differential.

3. The system of claim 1 wherein said first and second eye member securing members and said first and second threaded orifices of said stabilization rod member are respectively configured to constitute first and second hime joints assemblages.

4. The system of claim 2 wherein said first and second eye member securing members and said first and second threaded orifices of said stabilization rod member are respectively configured to constitute first and second hime joints assemblages.
